(19) United States
(12) Patent Application Publication
(10) Pub. No.: US 2009/0194449 A1
(43) Pub. Date: Aug. 6, 2009

(54) BEVERAGE CONTAINER WITH READILY IDENTIFIABLE LABEL

(76) Inventor: Tsung-Hsien Wu, Taipei City (TW)

Correspondence Address: LEONG C LEI, PMB # 1008, 1867 YGNACIO VALLEY ROAD, WALNUT CREEK, CA, 94598, US

(21) Appl. No.: 12/025,785

(22) Filed: Feb. 5, 2008

(51) Int. Cl. B65D 85/00; B42D 15/00

(52) U.S. Cl. 206/459.5; 283/74

(57) ABSTRACT

A beverage container, such as a PET (Polyethylene Terephthalate) bottle or a cup or a can, is provided with a readily identifiable label by providing a scratch-off film on an outside surface of a container body. The scratch-off film has a distinct color for eye catching and is easy to scratch off to provide a beverage container with an identification mechanism. The scratch-off film has an effective area that can be scratched off by a user to form an easily recognizable mark, such as figure, a character, or a pattern, to allow the user to identify the user's own beverage among a number of identical beverage containers. Thus, sanitary and safety problems caused by mistakenly drinking other's beverages or disposal of incompletely-consumed beverage containers caused by un-recognition of the beverage containers can be eliminated.

### BACKGROUND OF THE INVENTION

(a) Technical Field of the Invention

The present invention relates to a beverage container with readily identifiable label, which is designed for providing an easy solution for marking and identification all sorts of beverage containers, such as PET (Polyethylene Terephthalate) bottles and cups and cans so that similar beverage containers, after being opened, can easily identified to completely resolve the problems of mistakenly drinking other's beverage or unnecessarily disposing of incompletely-consumed beverage containers simply for health and safety concerns.

Based on such a goal to achieve, the starting point of the present invention is to realize easy recognition or identification. Thus, with such a goal and starting point, the beverage containers must be identified by directly making some simple marks, symbols, identifications, such as figures, characters, or patterns on an outside appearance or package or any eye-catching locations thereof without using any additional tools or assisting measures so that already-opened containers can be clearly marked and easily identified among other similar containers whereby problems related to sanitary, health, and safety of consuming beverage can be overcome and environmental protection and saving of resources are realized and ultimate solution to conservation of water resources is provided.

Based on the above described requirements, the present invention is made so that simple marks, characters, or patterns can be formed, by scratching, on an effective area, which allows a user to make the user's own identification, provided on each container of a huge number of identical containers, or bottles, cups, or cans, whereby an identifiable label is formed on the container. The area for forming the identifiable label is formed by a scratch-off film that is of distinct color and is easy to scratch off and can be formed on beverage containers by for example automatized transfer printing or sticking so that when a beverage container is opened for consumption, the scratch-off film can be scratched off by the user to exhibit a simple mark to allow easy and efficient identification of the opened beverage container among a number of identical containers, which ultimately resolves the problems associated with the concerns of safety for beverage consumption, saving of resources, environmental protection, and conversation of water resources.

(b) Description of the Prior Art

Beverages or liquid food or water packaged in a PET (Polyethylene Terephthalate) bottle or a cup or a can is commonly available in the market and they provide the general consumers with convenient and immediate access to the drinks. However, the packaged beverages produce a significant environment problem for they increase the overall amount of garbage and the material used to package the beverage causes problems for environmental protection. The only solution that is currently taken is to recycle the used containers of beverage.

Careful inspection and study reveal that among all the disposed beverage containers, a great number of the beverage containers are incompletely consumed, which means the beverages contained in the containers are just partly drunk or consumed. This is not just a waste of the un-consumed beverage, and it is also a problem of environmental protection for the contamination caused by the disposed containers is made worse by the incompletely consumed products and the burden for recycling the containers is increased.

It is found that some of the incompletely-consumed beverage containers are disposed of simply because there is no easy way to clearly identify an opened container among a number of identical beverage containers. In order to avoid any mistake and risk of drinking other's beverage to cause undesired sanitary and health problems, those un-identified and opened beverage containers are disposed of. This directly results in the above discussed problems of waste and environmental protection.

### SUMMARY OF THE INVENTION

The primary purpose of the present invention is to provide a solution for ready and easy marking and identification of generally used beverage containers, such as PET (Polyethylene Terephthalate) bottles, cups and cans, so that a beverage container has been opened, a user is allowed to readily identify his or her beverage among a number of identical beverage containers, whereby mistakenly drinking other's beverages or waste caused by disposal of incompletely-consumed beverage container and sanitary and safety of beverage consumption associated with un-recognition of one's own beverage can be effectively overcome.

The solution of the present invention is to provide a beverage container with capability of easy marking and ready identification, wherein a scratch-off film of a distinct or eye-catching color and being easy for scratching is formed or provided on an outside surface of a beverage container by means of transfer printing or sticking or other known means so that the scratchabiltiy that the scratch-off film features allows the user to make a simple mark or identification in an effective area of the scratch-off film. Thus, after a beverage container has been opened, the user is allowed to readily identify the user's own beverage among a number of identical beverage containers and mistakenly taking and drinking other's beverages can be effectively avoided.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a perspective view of an embodiment of the present invention;

FIG. 2 is a plan view illustrating an application of the present invention in shrinkage film that is then used to wrap around a beverage container;

FIG. 3 is a plan view illustrating another application of the present invention in shrinkage film that is then used to wrap around a beverage container; and

FIG. 4 shows a perspective view of another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

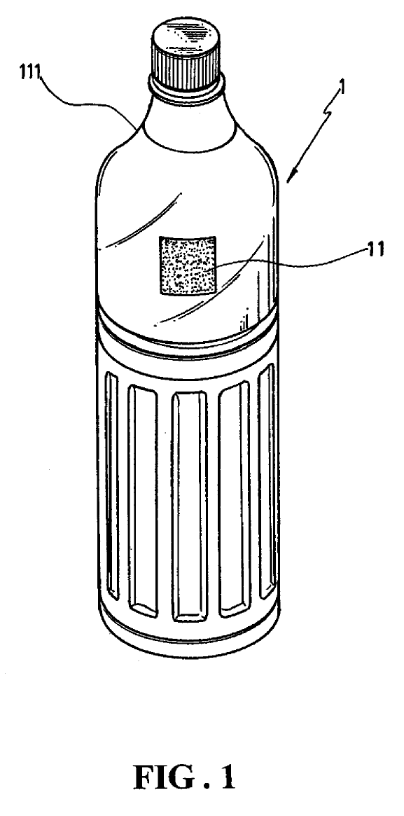

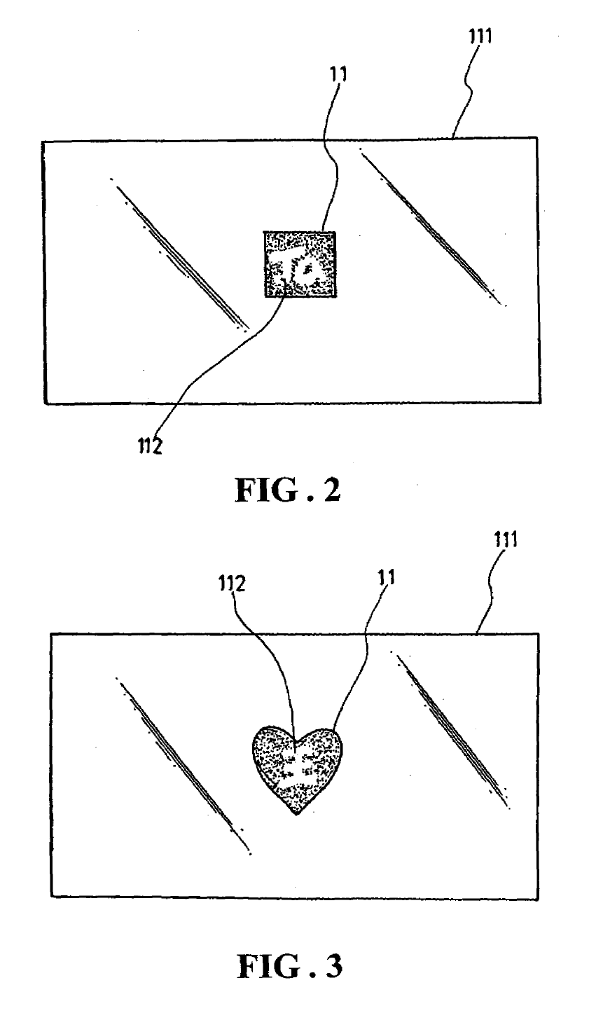

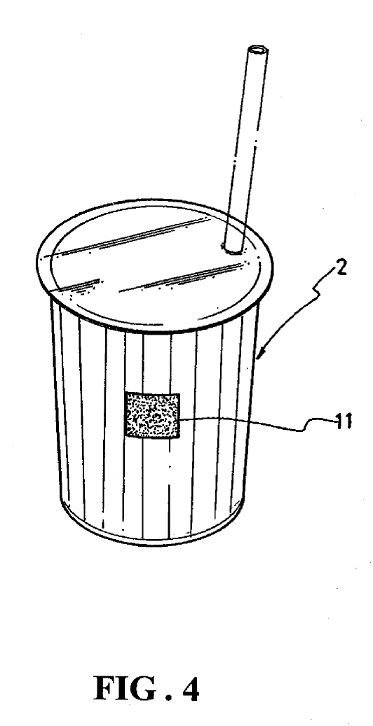

With reference to the drawings and in particular to FIGS. 1 and 4, the present invention is generally applicable to various beverage containers, such as a PET (Polyethylene Terephthalate) bottle 1 or a cup 2 or even a can by attaching a scratch-off film 11, which functions for identification and is readily identifiable, to a body of the container. Thus, once the container is opened by a user, the container can be marked by the user by making a scratch or mark 112, such as a figure, a character, or an easily-recognizable pattern, in an effective area of the scratch-off film 11 as illustrated in FIGS. 2 and 3. This allows the user or other persons to clearly identify his or her own beverage and disposable of an incompletely-consumed beverage container caused by un-recognition of his or her beverage can be avoided and sanitary and safety of beverage consumption can be ensured.

Further referring to FIG. 1, the scratch-off film 11 that is provided in accordance with the present invention can be formed in various ways, such as automatic transfer printing that directly prints the scratch-off film on the container body; or alternatively, the scratch-off film can be transferred to a shrinkage film or a decoration film wrapped around or mounted to the container body. Or, the scratch-off film 11 can be directly formed on an outside surface of the container body. The scratch-off film 11 can be made of various, arresting color and/or various forms to ensure clear and eye-catching identification, as best illustrated in FIGS. 2 and 3.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A beverage container with readily identifiable film, comprising a container body on which a scratch-off film having an effective area is provided, wherein the effective area of the scratch-off film allows a user to make an identifiable mark by scratching.

2. The beverage container as claimed in claim 1, wherein the scratch-off film is formed on the container body by means of transfer printing or sticking.

3. The beverage container as claimed in claim 1, wherein the scratch-off film is made of various colors.

4. The beverage container as claimed in claim 1, wherein the scratch-off film is made of various forms.
